(19) United States
(12) Patent Application Publication
(10) Pub. No.: US 2013/0000810 A1
(43) Pub. Date: Jan. 3, 2013

(54) Systems and Methods for Applying Decals to Substrates

(75) Inventors: James Preston David, Atlanta, GA (US); Jim Davis, KeyLargo, FL (US); Austin Jack Woods, Atlanta, GA (US)

(73) Assignee: Cool Works Cup, LLC., Key Largo, FL (US)

(21) Appl. No.: 13/173,233

(22) Filed: Jun. 30, 2011

(51) Int. Cl. B32B 37/10; B32B 37/14; B32B 37/06

(52) U.S. Cl. 156/60; 156/580; 156/499

(57) ABSTRACT

In one embodiment, a decal applicator machine includes a main frame, a decal frame supported by the main frame, the decal frame being adapted to securely hold a decal during application of the decal to a substrate, a deformable element adapted to support the decal during its application to the substrate, a substrate support element to which the substrate mounts, and drive means for driving the substrate into the decal and into the deformable member to firmly apply the decal to the substrate.

### BACKGROUND

Many manufactured products include decals or stickers that are applied to the product. Such decals, particularly larger decals, are often applied to the product by hand, which can be time consuming. Moreover, it can be difficult to apply such decals by hand, particularly to uneven and/or curved surfaces. It would be desirable to have a system and method for automating the decal application process.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a perspective view of an embodiment of a decal applicator machine.

FIG. 2 is a front view of the decal applicator machine of FIG. 1.

FIG. 3 is a side view of the decal applicator machine of FIG. 1.

FIG. 4 is a perspective view of an embodiment of a decal that is to be applied to a substrate.

FIG. 5 is a perspective view of an embodiment of a substrate to which a decal is to be applied.

FIGS. 6A-6I are sequential perspective views illustrating an embodiment of a method for applying a decal to a substrate.

### DETAILED DESCRIPTION

As described above, it would be desirable to automate the process of applying decals to a product during the manufacturing process. Described herein are examples of such systems and methods. In one embodiment, a decal applicator machine is provided that is used to apply a decal to a substrate, such as a lid of a drink/food cooler. In some embodiments, the decal can be applied to the substrate by placing the decal in a decal frame, heating the decal, positioning a deformable element below the decal, and pressing the substrate into the decal and the deformable element to bond the decal to the substrate.

In the following disclosure, various embodiments are described. It is to be understood that those embodiments are merely example implementations of the disclosed inventions and that alternative embodiments are possible. All such embodiments are intended to fall within the scope of this disclosure.

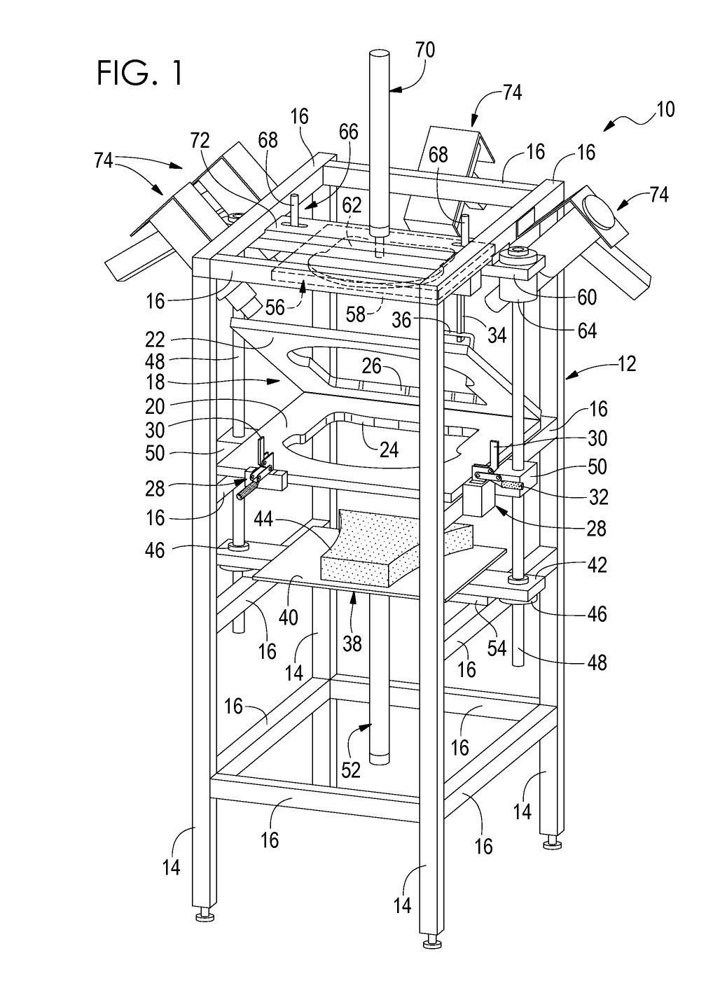

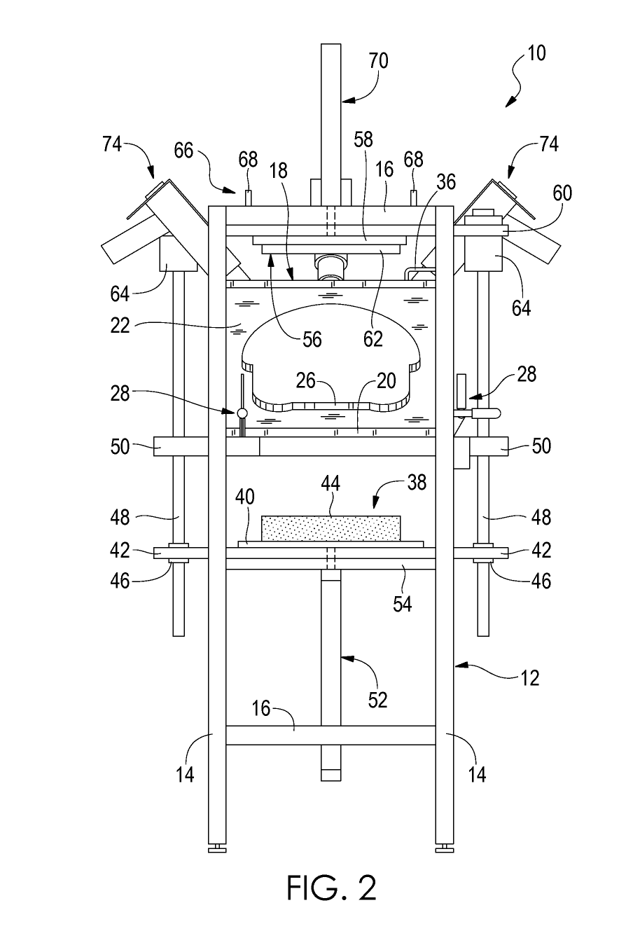

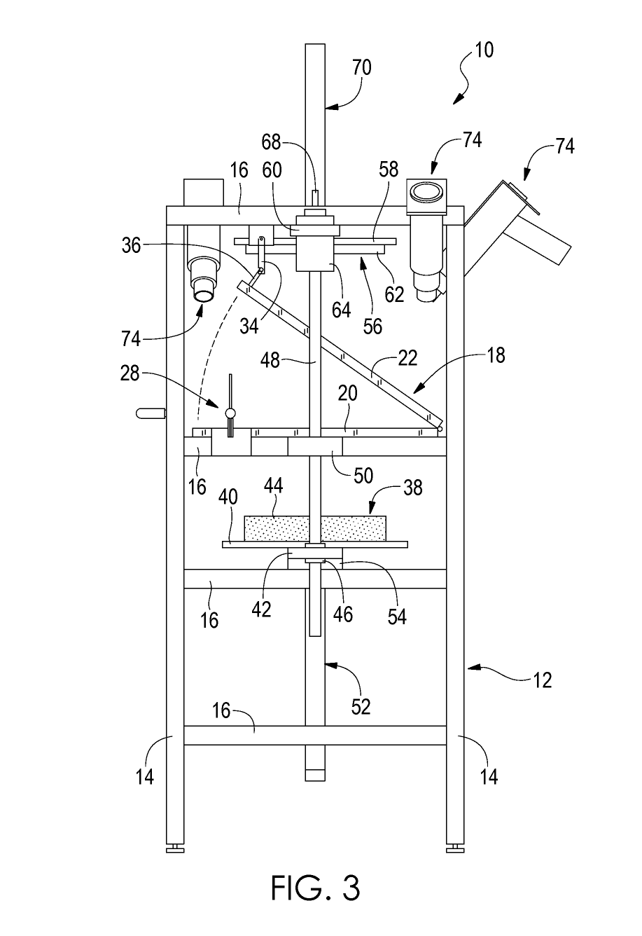

FIGS. 1-3 illustrate an example decal applicator machine 10 that can be used to apply a decal to a substrate. In the discussion that follows, the substrate is assumed to be a lid of a drink/food cooler that emulates the shape of a race car hood, and the decal is assumed to be a decal that includes markings of the type that might be displayed on a race car hood.

As shown in FIGS. 1-3, the machine 10 comprises a main frame 12 that includes various vertical beams 14 and horizontal beams 16. In some embodiments, the beams 14, 16 are made of a metal such as steel or aluminum and are welded, fastened, or otherwise secured together so that the frame 12 forms a rigid, unitary structure. In some embodiments, the frame 12 is relatively tall and narrow and has a generally square footprint. By way of example, the frame 12 can be approximately 4 to 5 feet tall and each side of the frame can be approximately 2 to 3 feet wide. Although not shown in the figures, the frame 12 can be at least partially enclosed by one or more exterior panels. For example, multiple panels of clear plastic (e.g., acrylic laminate panels) can be applied to the outside of the frame 12 to enclose at least part of the interior space of the frame to ensure adequate heating of the decal prior to its application to the substrate.

Mounted to two of the horizontal beams 16 approximately halfway along the height of the frame 12 is a decal frame 18. The decal frame 18 is used to hold the decal in place both before and during its application to the substrate. In the illustrated embodiment, the decal frame 18 includes a generally flat bottom plate 20 and a generally flat top plate 22 that is adapted to rest on top of the bottom plate. In some embodiments, both plates 20, 22 are made of a metal material, such as aluminum. Irrespective of its material, each plate 20, 22 has an opening 24, 26 that is adapted to provide access to the decal when it is secured by the decal frame 18. Each opening 24, 26 is similarly sized and shaped. In some embodiments, the openings each have a shape that is similar to the decal but is slightly smaller than the decal so that the edges of the decal can be secured between the plates 20, 22.

In the illustrated embodiment, the top plate 22 is hinged to the bottom plate 20 so that the top plate be can closed on the bottom plate like a clam shell. The decal frame 18 further includes two locking mechanisms 28 that can be manipulated by the operator to lock the top plate 22 down on top of the bottom plate 20 when a decal is positioned between the two plates. In the illustrated embodiment, the locking mechanisms 28 comprise bars 30 that clamp down on top of the top plate 22 when handles 32 of the mechanisms are pivoted upward. When not in use, the top plate 22 can be suspended above the bottom plate 20 using a hanging element 34 that latches onto a handle 36 of the top plate.

Positioned below the decal frame 18 within the main frame 12 is a decal support member 38 that can be moved up and down within the main frame (i.e., toward and away from the decal frame 18). The decal support member 38 generally comprises a plate 40 that is mounted on a crossbeam 42 and a deformable element 44 that is mounted on the plate. The plate 40 is generally flat and rectangular. In some embodiments, the plate 40 is made of a metal material, such as aluminum.

The crossbeam 42 can be constructed of a metal such as steel or aluminum and supports the plate 40 and the deformable element 44. The crossbeam 42 extends beyond the sides of the frame 12 and includes bushings 46 that are slidingly mounted on vertical guide rods 48 positioned outside of the frame that guide the decal support member 38 as it is moved up and down within the frame. In some embodiments, the guide rods 48 are made of steel and are fixedly mounted to the frame 12 with mounting blocks 50 that are secured to the horizontal beams 16 that support the decal frame 18.

The deformable member 44 is made of an easily deformable material, such as a polymeric foam material, and is sized and shaped to fit within the edges of the openings 24, 26 formed in the top and bottom plates 20, 22 of the decal frame 18. As is described below, the deformable element 44 can support the decal from below both prior to clamping the decal within the decal frame 18 and when the decal is physically applied to the substrate. When the decal is applied to the substrate, the substrate can be driven down into the decal and the deformable element 44 to evenly press the decal against the surface of the substrate.

Upward and downward displacement of the decal support member 38 is provided by a first or bottom drive element 52. In the illustrated embodiment, the drive element 52 comprises a pneumatic cylinder that is mounted to a fixed crossbeam 54. The drive element 52 includes an outer cylinder and an inner piston. During use, the piston can be extended from and retracted into the cylinder depending upon the state of pressurization of the cylinder with a drive gas, such as air.

Positioned above the decal frame 18 within the main frame 12 is a substrate support member 56 that can be moved down and up within the main frame (i.e., toward and away from the decal frame 18). The substrate support member 56 generally comprises a plate 58 that is mounted to a crossbeam 60 and a substrate support element 62 that is mounted to the plate. The plate 58 is generally flat and rectangular. In some embodiments, the plate 58 is made of a metal material, such as aluminum.

The crossbeam 60 can be constructed of a metal such as steel or aluminum and supports the plate 58 and the support element 62. Like the crossbeam 42, the crossbeam 60 extends beyond the sides of the frame 12 and includes bushings 64 that are slidingly mounted on the vertical guide rods 48 outside of the frame. The guide rods 48 guide the substrate support member 56 as it is moved down and up within the frame 12. The crossbeam 60 further supports locking mechanisms 66 that are used to lock the substrate once it has been placed on the support element 62. In the illustrated embodiment, the locking mechanisms comprise levers 68 that can be actuated to lock and unlock the substrate.

The substrate support element 62 can be made of rigid material, such as aluminum, and is sized and shaped to receive the substrate. In some embodiments, the support element 62 is contoured to match the shape of the inside surface of the substrate (i.e., the surface on the opposite side of the surface to which the decal will be applied) so that the substrate can be evenly urged into the decal during application.

Downward and upward displacement of the substrate support member 56 is provided by a second or top drive element 70. In the illustrated embodiment, the drive element 70 comprises a pneumatic cylinder that is mounted to a fixed crossbeam 72 and that includes an outer cylinder and an inner piston. During use, the piston can be extended from and retracted into the cylinder depending upon the state of pressurization of the cylinder with a drive gas, such as air.

The decal applicator machine 10 can further include one or more heating elements 74 that can be used to heat the decal before it is applied to the substrate. In the illustrated embodiment, the heating elements 74 comprise multiple heat guns that expel hot air directly toward the decal when it is held by the decal frame 18.

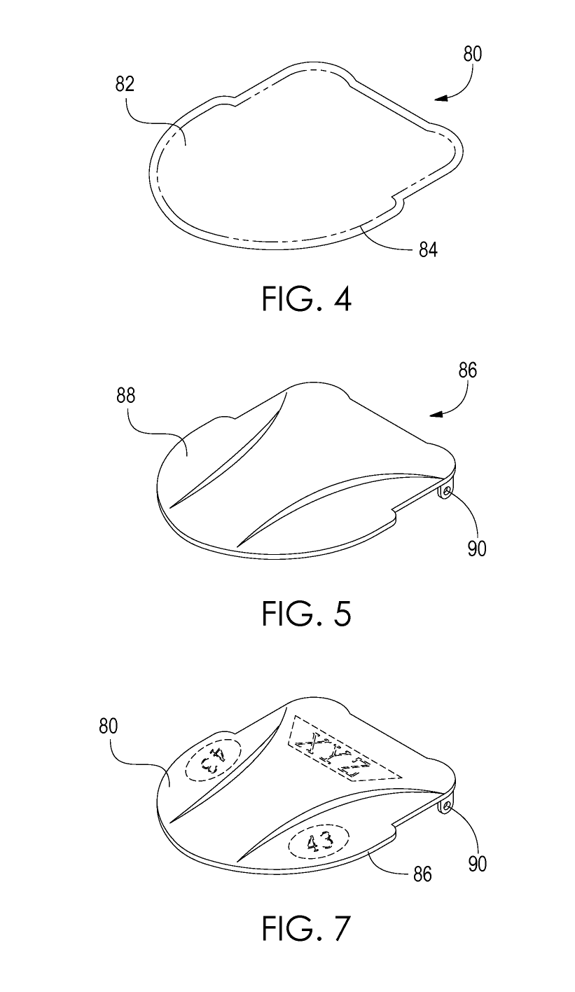

The primary components of the decal applicator machine 10 having been described above, an example decal application process will now be discussed. FIG. 4 illustrates an example decal 80 that can be applied to a substrate. The decal 80 is shown bottom-side-up, such that the inner surface 82 that is to be applied to the substrate is visible. In some embodiments, the inner surface 82 is provided with a layer of adhesive that enables the decal 80 to adhere to the substrate. Indicated with broken lines 84 is the outline of what ultimately will be the final outer edge of the decal 80 after trimming. In some embodiments, that edge generally corresponds with the edges of the substrate.

FIG. 5 illustrates an example substrate 86 to which the decal 80 can be applied. The substrate 86 is generally planar but includes surface features to which the decal 80 must adhere. Specifically, the substrate 86 has uneven surfaces to which the decal 80 must conform. In the example of FIG. 5, the substrate 86 is a lid of a drink/food cooler and is shaped to emulate the hood of a race car. The outer surface 88 of the lid is shown in FIG. 5, which is the surface to which the decal 80 will be applied. As is further shown in FIG. 5, the lid includes tabs 90 that facilitate hinged attachment to the body of the cooler (not shown).

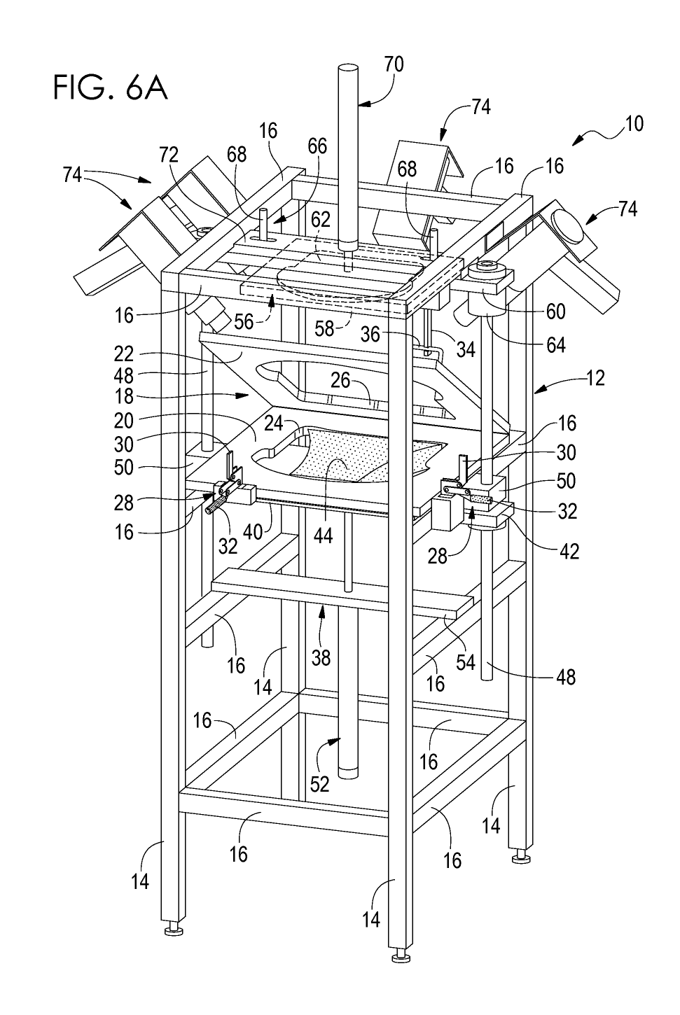

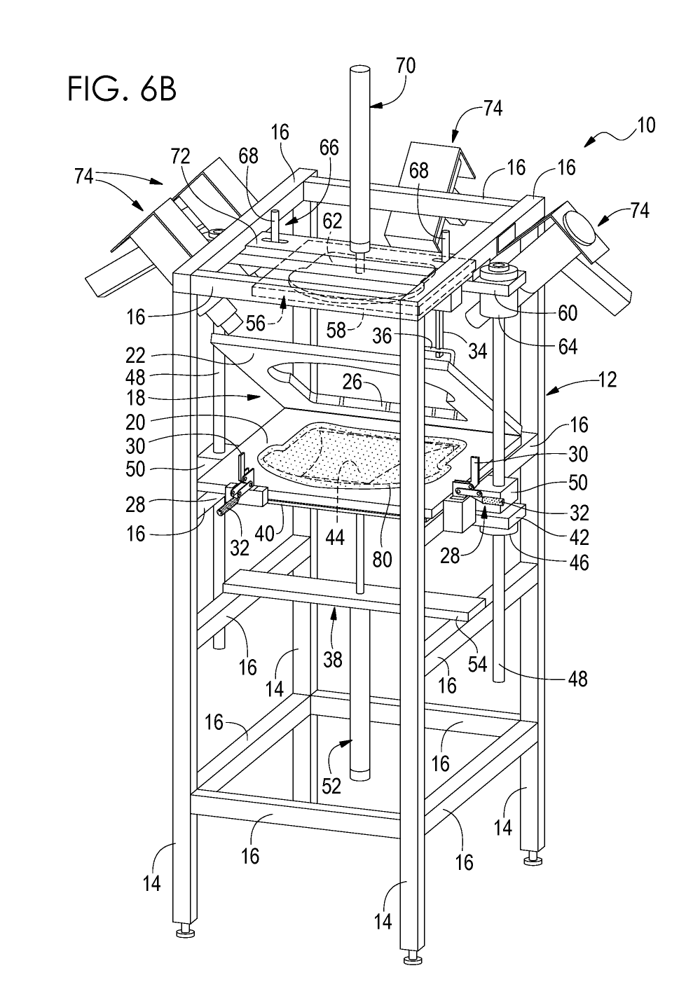

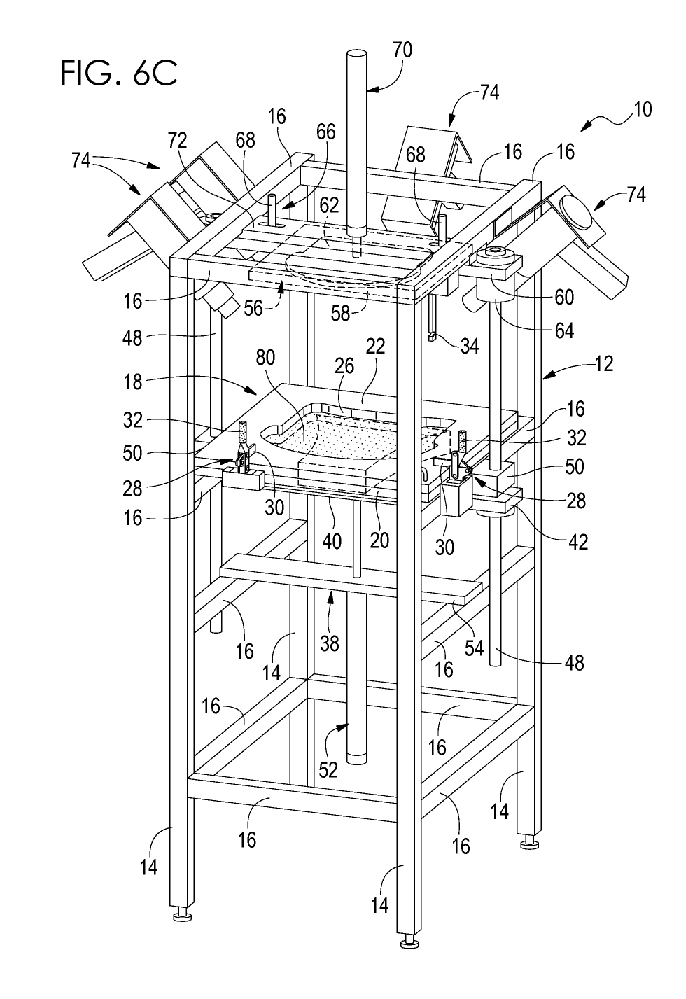

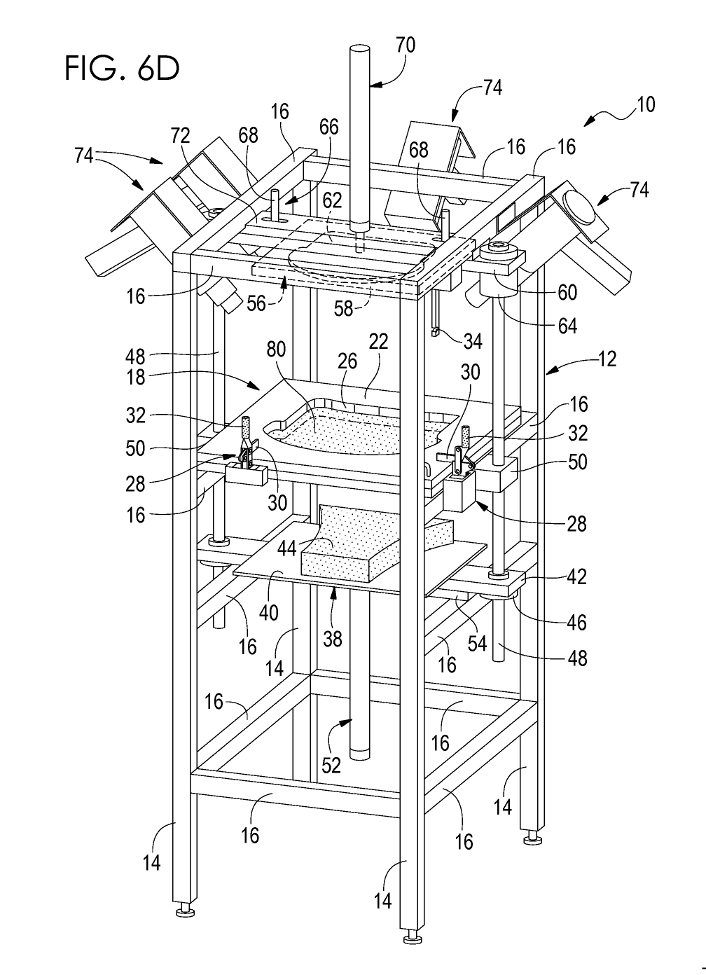

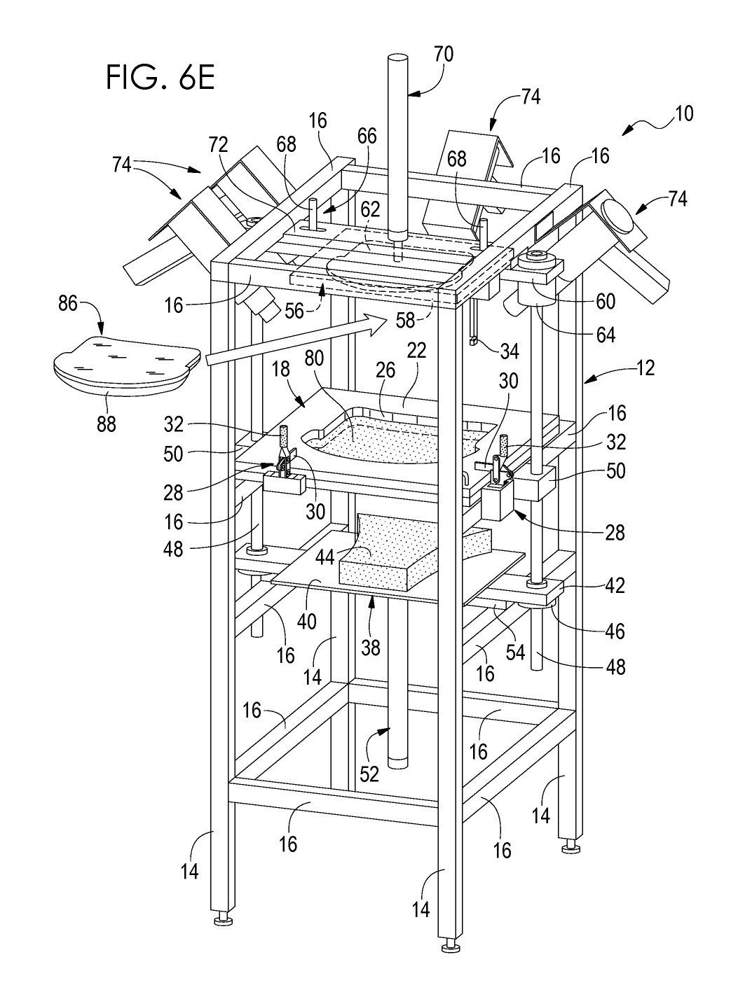

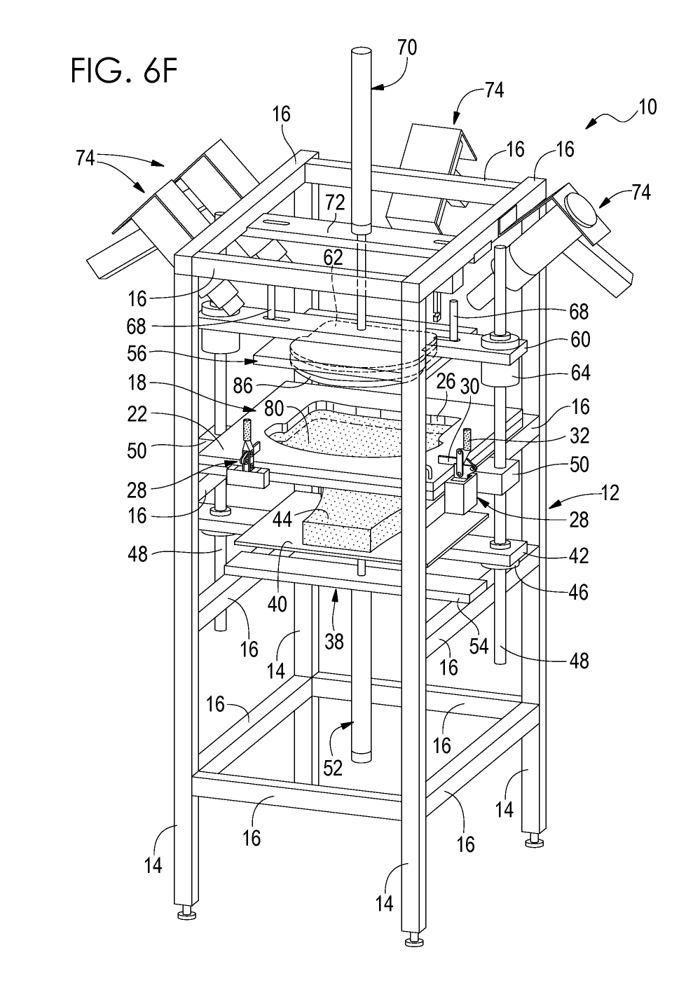

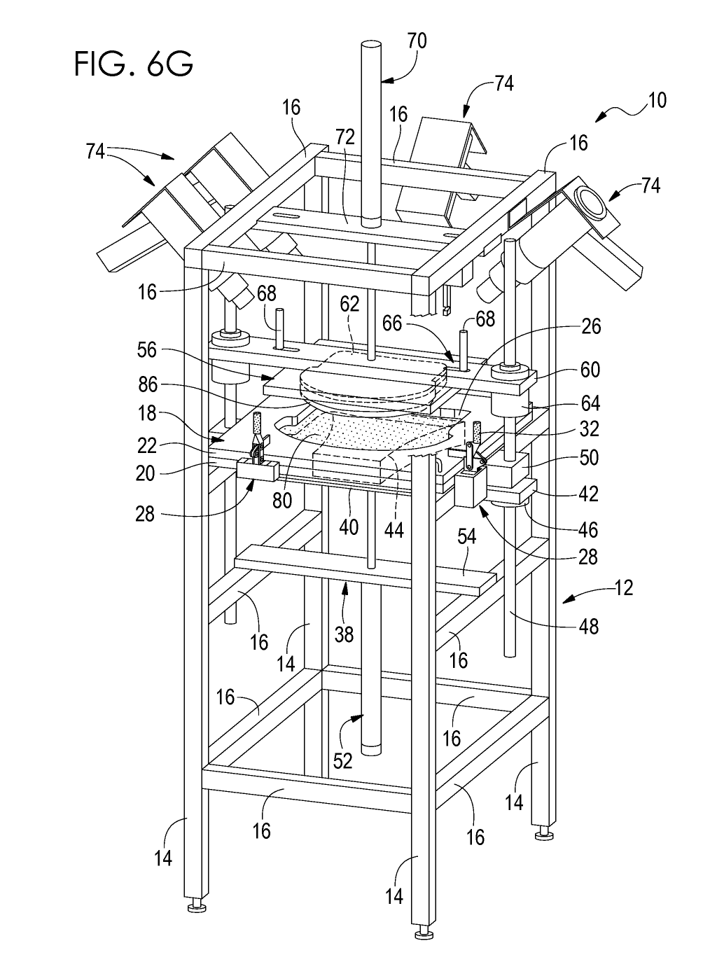

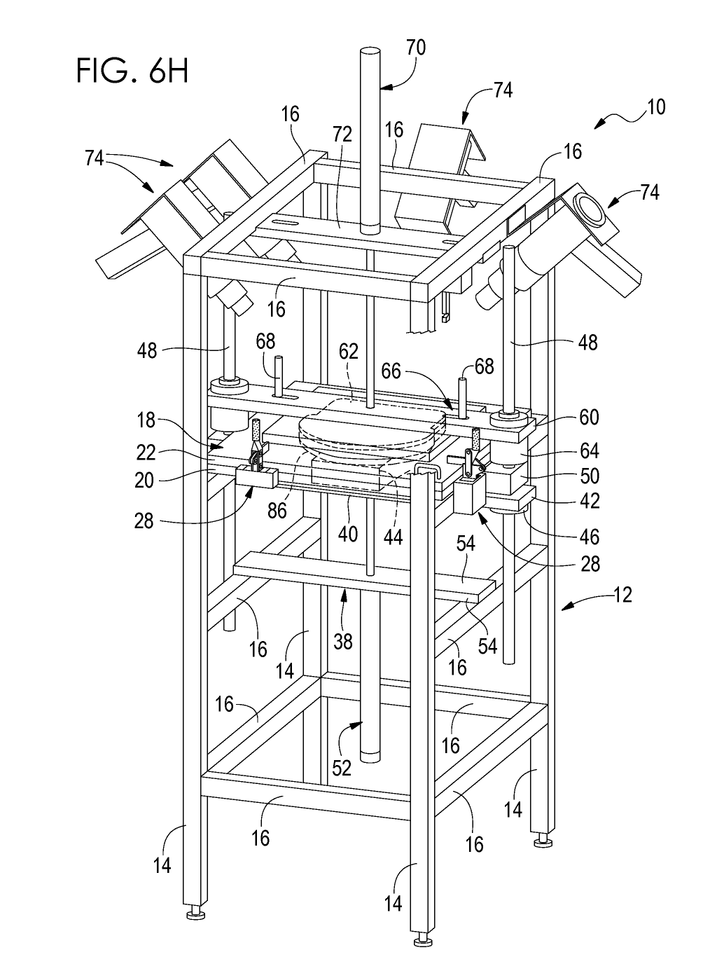

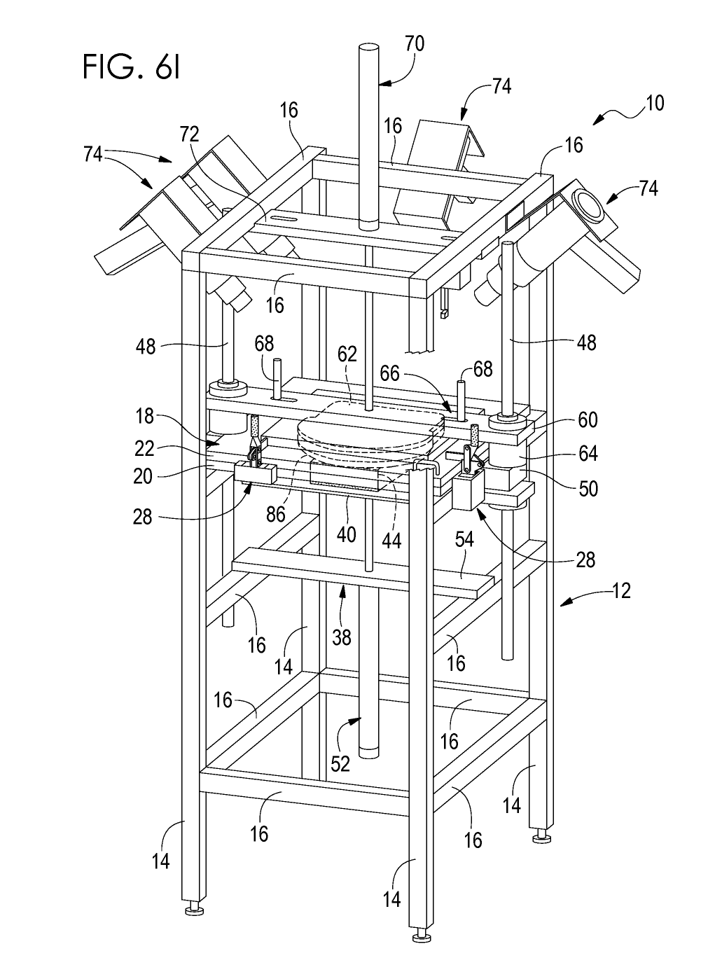

FIGS. 6A-6I show various steps in an example method for applying the decal 80 to the substrate 86 using the decal applicator machine 10. Beginning with FIG. 6A, the machine 10 is in an initial orientation in which the substrate support member 56 is in an uppermost position, the decal frame 18 is open (i.e., the top plate 22 is supported by the hanging element 34), and the decal support member 38 is also in an uppermost position. When the machine 10 is in that orientation, the deformable element 44 (of the decal support member 38) is positioned within the opening 24 of the bottom plates 20 of the decal frame 18.

Referring next to FIG. 6B, the decal 80 is placed over the opening 24 of the bottom plate 20 of the decal frame 18 with its inner surface 82 facing upward. By way of example, the decal 80 is manually laid over the opening 24 such that decal completely covers the opening and the edges of the decal are positioned beyond the edges of the opening. Because the decal support member 38 is in the uppermost position, the deformable element 44 supports the center of the decal 80 from below.

Next, the top plate 22 of the decal frame 18 is closed down on top of the edges of the decal 80 and the bottom plate 20, as shown in FIG. 6C. Specifically, the top plate 22 is released from the hanging element 34 and is pivoted about its hinge so that it ultimately lies flat on top of the bottom plate 20 with the decal 80 positioned between the top and bottom plates. To lock the top plate 22 in place on top of the bottom plate 20, the locking mechanisms 28 are actuated, for example by pivoting the handles 32 of the locking mechanisms upward. With the decal 80 locked between the bottom and top plates 20, 22, the desired amount of tension can be maintained for the decal as it is applied to the substrate 86.

Once the top plate 22 of the decal frame 18 has been locked in place on top of the bottom plate 20, the decal 80 is securely held by the decal frame. Therefore, the support of the deformable element 44 of the decal support member 38 is no longer needed. Because of this, the decal support member 38 can be moved downward away from the decal 80. In some embodiments, the decal support member 38 can be moved to its lowermost position as shown in FIG. 6D. By way of example, the decal support member 38 can be placed in that position using the bottom drive element 52.

With reference next to FIG. 6E, a blank substrate 86 is mounted to the substrate support member 56. In some embodiments, the substrate 86 is manually attached to the substrate support member 56 and is locked in place on the member using the locking mechanisms 66. By way of example, when the levers 68 of the locking mechanisms 66 are pushed outwardly, clamps (not shown) associated with the substrate support member 56 firmly grip the edges of the substrate 86 along its sides.

At this point, both the decal 80 and the substrate 86 are fixedly secured within the machine 10 and the decal can be applied to the substrate. Before doing so, however, the decal 80 can be heated to ensure that it will conform to the contours of the substrate 86. In some embodiments, this is achieved using the heating elements 74. In cases in which the interior space of the machine 10 is enclosed by exterior panels, a door (not shown) that provides access to the front of the decal frame 18 can be closed and the heating elements 74 can be activated to blow hot air on the decal 80 to heat it.

Once the decal 80 has been adequately heated, both the decal support member 38 and the substrate support member 56 can be actuated to move toward the decal frame 18. In some embodiments, both members 38, 56 are simultaneously driven toward the decal frame 18, and the decal 80 it holds, by the bottom and top drive elements 52 and 70, respectively. FIG. 6F shows the decal support member 38 after it has been moved upward toward the decal frame 18, and the substrate support member 56 after it has been moved downward toward the decal frame.

FIG. 6G illustrates a point in the process in which the decal support member 38 is again positioned in its uppermost position with the deformable element 44 again contacting the decal 80. At that point, the substrate support member 56 is still traveling downward toward the decal frame 18, but has nearly reached the decal frame. As movement of the substrate support member 56 continues, the substrate 86 eventually passes through the opening 26 in the upper plate 22 of the decal frame 80 and contacts the decal 80, as shown in FIG. 6H. Through continued downward movement of the substrate support member 56, the substrate 86 is firmly pressed into the decal 80 and the deformable element 44 that supports the decal. Accordingly, the substrate 86 and the substrate support element 62 deforms the deformable element 44 with the decal 80 between the substrate and the deformable element to force the decal to conform to the contours of the outer surface of the substrate. In some embodiments, the substrate support member 56 further drives the decal support member 38 downward along the rails 48, as shown in FIG. 6I.

At this point, the decal 80 has fused to the substrate 86 and the decal application process has been completed. The locking mechanisms 66 that hold the substrate 86 to the substrate support member 56 can therefore be released and the substrate support member and the decal support member 38 can be moved away from the decal frame 18. Next, the locking mechanisms 28 that lock the decal frame 18 can be released and the top plate 22 of the decal frame can be raised and hung on the hanging element 34. The substrate 86 and its applied decal 80 can then be withdrawn from the decal frame 18 and the decal applicator machine 10. Any excess decal 80 that extends beyond the edges of the substrate 86 can then be trimmed, for example using a sharp blade. FIG. 7 shows an example of the finished product, with the decal 80 firmly adhered to the top surface of the substrate 86.

With the above-described applicator machine, decals can be applied to substrates much more easily and in far less time than would be necessary if the decals were applied to the substrates by hand. By way of example, a decal can be applied to a substrate in about 2 minutes using the machine, whereas about 45 minutes may be required when the decal is applied by hand.

Claimed are:

1. A decal applicator machine comprising:
a main frame;
a decal frame supported by the main frame, the decal frame being adapted to securely hold a decal during application of the decal to a substrate;
a deformable element adapted to support the decal during its application to the substrate;
a substrate support element to which the substrate mounts; and
drive means for driving the substrate into the decal and into the deformable member to firmly apply the decal to the substrate.

2. The machine of claim 1, wherein the decal frame has a top plate and bottom plate between which the decal is firmly held.

3. The machine of claim 2, wherein the top plate is hinged to the bottom plate.

4. The machine of claim 2, wherein the top plate and bottom plate each have an opening formed through them.

5. The machine of claim 4, wherein the openings are smaller than the decal.

6. The machine of claim 2, further comprising a locking mechanism that secures the top plate in place on top of the bottom plate.

7. The machine of claim 1, wherein the deformable member is positioned within the main frame below the decal frame.

8. The machine of claim 1, wherein the decal frame defines an opening and the deformable element is sized and shaped to fit within the opening.

9. The machine of claim 1, wherein the deformable element is made of a foam material.

10. The machine of claim 1, wherein the substrate support element is positioned within the main frame above the decal frame.

11. The machine of claim 1, wherein the substrate support element is contoured to match the shape of the inside surface of the substrate.

12. The machine of claim 1, further comprising a locking mechanism with which the substrate can be locked to the substrate support element.

13. The machine of claim 1, wherein the drive means include a first pneumatic cylinder that drives the deformable element and a second pneumatic cylinder that drives the substrate support element.

14. The machine of claim 1, further comprising heating means for heating the decal when held by the decal frame.

15. The machine of claim 14, wherein the heating means comprise a heat gun.

16. A decal applicator machine comprising:
a main frame;
a decal frame fixedly mounted to the main frame, the decal frame including a bottom plate and a top that are adapted to securely hold a decal between them during application of the decal to a substrate, wherein each of the plates have an opening through which the decal can be accessed, the openings being smaller in size than the decal;
a decal support member positioned within the main frame below the decal frame, the decal support member including a deformable element adapted to support the decal during its application to the substrate, the deformable element being sized and configured to fit within at least one of the openings of the plates;
a substrate support member positioned within the main frame above the decal frame, the substrate support member including a substrate support element to which the substrate mounts;
heating elements that heat the decal before it is applied to the substrate; and
first and second drive elements for respectively driving the decal support member and the substrate support member inward toward the decal frame, wherein the first drive element moves the deformable element to a position at which the deformable element supports the decal from below and wherein the second drive element presses the substrate into both the decal and the deformable member.

17. The machine of claim 16, wherein the top plate is hinged to the bottom plate.

18. The machine of claim 16, wherein the decal frame further comprises a locking mechanism that secures the top plate in place on top of the bottom plate.

19. The machine of claim 16, wherein the deformable element is made of a foam material.

20. The machine of claim 16, wherein the substrate support element is contoured to match the shape of the inside surface of the substrate.

21. The machine of claim 16, wherein the substrate support member includes a locking mechanism with which the substrate can be locked to the substrate support element.

22. The machine of claim 16, wherein the heating elements comprise heat guns directed at the decal frame.

23. A method for applying a decal to a substrate, the method comprising:
placing a decal within a decal frame that securely holds edges of the decal but leaves the center of the decal exposed;
positioning on one side of the decal a deformable element;
placing a substrate on a substrate support element on the opposite side of the decal;
driving the substrate into the decal and the deformable element using the substrate support element to apply the decal to the substrate.

24. The method of claim 23, wherein placing the decal in a decal frame comprises clamping the edges of the decal with two opposed plates of the decal frame.

25. The method of claim 23, wherein driving the substrate comprises driving the substrate using a pneumatic cylinder.
